(19) United States
(12) Patent Application Publication
(10) Pub. No.: US 2003/0015867 A1
(43) Pub. Date: Jan. 23, 2003

(54) Document recording form for receiving electronically imaged data and a system and a method for using same

(76) Inventor: Glenn Petkovsek, Little Rock, AR (US)

Correspondence Address: PATENTS+TMS, A Professional Corporation, 1914 North Milwaukee Avenue, Chicago, IL, 60647, US

(21) Appl. No.: 09/908,282

(22) Filed: Jul. 18, 2001

(51) Int. Cl. B42D 15/00

(52) U.S. Cl. 283/81

(57) ABSTRACT

A form is provided to accompany a document to be recorded as well as a method and system for using the same. The form may receive electronically-imaged data relevant to the recording of the document. The form may have a first layer having detachable parts on which information may be imaged. The form may also have a second layer which may be attached to the first layer. The first layer may be removable from the second layer. Data for the recording of a document may be accessed via the internet, for example, and may be printed onto the form by, for example, a printer. One or more of the detachable parts may then be removed from the second layer and may be attached to the document to be recorded.

### BACKGROUND OF THE INVENTION

The present invention generally relates to a form for printing information relating to recorded documents. More specifically, the present invention relates to a form which may have a plurality of detachable parts capable of having information, such as, for example, user data, government data, and the like, printed thereon by a printer or the like. The form may have two sheets: a first sheet having a plurality of detachable parts and a second sheet to which the first sheet is adhesively and removably attached. Electronically-imaged information, accessed, for example, through the internet, may be printed on the form.

It is, of course, generally known to record certain documents with an organization, such as, for example, a government. Often, when a document is recorded, an individual receives a receipt, for example, or the like, acknowledging that the document has been received by the organization, such as the government. However, the recording process is often time-consuming and/or tedious. Documents often require review to verify, for example, organization and/or user information.

It is also generally known to provide forms on which information may be printed. Such forms may be used by an organization, such as the government, for example, in conjunction with documents that must be recorded with the organization. A user may print information on the form and may present the form and/or the document to the organization for recording. The form may serve as a receipt, for example, for the document received. However, certain forms may require manual printing which may be both a tedious and time-consuming task. In addition, many forms may not display all items of information necessary for a document to be recorded. Moreover, access to forms for recording documents may be limited. Users often face geographical, economical or other similar constraints to accessing forms for recording documents.

A need, therefore, exists for a form, a system and a method for preparing a form that may accompany a document recorded by an organization, such as, for example, a government. Further, a need exists for a form, a system and a method for preparing and recording a form in which information necessary for recording of the document may be printed in a single transaction.

### SUMMARY OF THE INVENTION

The present invention provides a form to accompany a document to be recorded and a method for using the same. The form may receive electronically-imaged data relevant to the recording of the document. The form may have a first layer having a plurality of detachable parts on which information may be imaged. The form may also have a second layer which may be adhesively attached to the first layer. Data integral to the recording of the document may be accessed via the internet, for example, and may be printed onto the form by, for example, a printer. One or more of the detachable parts may then be removed from the second layer and attached to the document to be recorded.

To this end, in an embodiment of the present invention, a form for recording of a document is provided. The form is comprised of a first layer and a backing layer. The first layer has a front side and a back side. Wherein the backside has an adhesive. The front side has a first label and a second label wherein the second label is a receipt. The backing layer is attached to the first layer by the adhesive. The first label and the second label on the front side receive electronically imaged information accessed over a global computer network wherein the electronically imaged information is necessary to effect the recording of the document.

In an embodiment, the form for recording of a document is further comprised of a value printed on the first label and on the second label wherein the value represents a fee paid for the recording of the document.

In an embodiment, the form for recording of a document is further comprised of a value caption on the second label indicative of payment.

In an embodiment, the form for recording of a document is further comprised of a fee caption on the second label.

In an embodiment, the form for recording of a document is further comprised of a mark on the first label wherein In an embodiment, the form for recording of a document is further comprised of a name printed on the first label and the second label wherein the name is indicative of an organization with which the document is recorded.

In an embodiment, the form for recording of a document is further comprised of an insignia on the first label indicative of an organization with which the document is recorded.

In an embodiment, the form for recording of a document is further comprised of identification information on the front side of the first label and the second label.

In an embodiment, the form for recording of a document is further comprised of bar code information on the first label and on the second label.

In an embodiment, the form for recording of a document is further comprised of security ink printed on the first label and on the second label.

In an embodiment, the form for recording of a document is further comprised of a descriptive caption on the second label wherein a serial number is printed.

In an embodiment, the form for recording of a document is further comprised of a descriptive caption on the second label wherein information is printed.

In an embodiment, the form for recording of a document is further comprised of a date on the first label and the second label wherein the date is indicative of the date the form is prepared.

In an embodiment, the form for recording of a document is further comprised of non-sequential numbering on the first label and the second label.

In an embodiment, the form for recording of a document is further comprised of a custom stamp having encrypted symbols on the first label.

In an embodiment, the form for recording of a document is further comprised of insurance information input by the user on the second label.

In another embodiment of the present invention, a system for recording of a document is provided. The system is comprised of a form having a first layer and a backing layer wherein the backing layer is adhesively attached to the first layer. The first layer has a front side having a first label and a second label wherein the first label and the second label receive electronically imaged information. The system if further comprised of a global computer network that transfers electronically imaged information to the form, means for remotely accessing the global computer network and means for printing the information accessed over a global computer network onto the form.

In an embodiment, the system for recording of the document is further comprised of a roll of forms wherein the forms are detachably connected.

In another embodiment of the present invention, a method for printing information relating to a recorded document is provided. The method is comprised of the steps of providing a form, providing a global computer network to a user, inputting information by the user to the global computer network and printing information from the global computer network to the form. The form has a first layer and a backing layer wherein the backing layer is adhesively attached to the first layer. The first layer has a first label and a second label wherein the second label is a receipt. The method is further comprised of the steps of removing the receipt from the form, removing the backing layer from the first label, and affixing the first label to the recorded document.

In an embodiment, the method for printing information relating to the recorded document is further comprised of the step of printing a value on the first label and on the second label wherein the value represents a fee paid for the recorded document.

In an embodiment, the method for printing information relating to the recorded document is further comprised of the step of printing a caption on the second label indicative of payment.

In an embodiment, the method for printing information relating to the recorded document is further comprised of the step of printing a mark on the first label wherein the mark is indicative of sufficiency of the form for the recorded document.

In an embodiment, the method for printing information relating to the recorded document is further comprised of the step of printing a name on the first label and on the second label wherein the name is indicative of an organization associated which the recorded document.

In an embodiment, the method for printing information relating to the recorded document is further comprised of the step of printing an insignia on the first label indicative of an organization associated with the recorded document.

In an embodiment, the method for printing information relating to the recorded document is further comprised of the step of printing information on the first label and the second label.

In an embodiment, the method for printing information relating to the recorded document is further comprised of the step of using security ink on the first label and on the second label.

In an embodiment, the method for printing information relating to the recorded document is further comprised of the step of printing a serial number on the second label.

In an embodiment, the method for printing information relating to the recorded document is further comprised of the step of printing information associated with a type of recorded document on the second label.

In an embodiment, the method for printing information relating to the recorded document is further comprised of the step of printing insurance information on the second label.

In an embodiment, the method for printing information relating to the recorded document is further comprised of the step of printing a date on the first label and the second label wherein the date is indicative of the date the form is prepared.

In an embodiment, the method for printing information relating to the recorded document is further comprised of the step of printing a security number on the first label and the second label.

In an embodiment, the method for printing information relating to the recorded document is further comprised of the step of printing a stamp number on the first label and the second label.

In an embodiment, the method for printing information relating to the recorded document is further comprised of the step of printing a custom stamp having encrypted symbols on the first label.

In an embodiment, the method for printing information relating to the recorded document is further comprised of the step of printing insurance information input by the user on the second label.

In an embodiment, the method for printing information relating to the recorded document is further comprised of the steps of providing a roll of forms wherein the forms are detachably connected and providing non-sequential numbering on the first label and on the second label.

It is, therefore, an advantage of the present invention to provide a form, and a system and method for using the same to allow greater convenience in recording a document.

Another advantage of the present invention is to provide a form, and a system and method for using the same to allow for more convenient access to information relevant to the recording of a document.

Yet another advantage of the present invention is to provide a form, and a system and method of using the same to allow less time-consumption in the printing of information on the form.

A still further advantage of the present invention is to provide a form, and a system and method of using the same allowing less time-consumption in the preparation of a document.

Additional features and advantages of the present invention are described in, and will be apparent from, the detailed description of the presently preferred embodiments and from the drawings.

### BRIEF DESCRIPTION OF THE DRAWINGS

FIG. 1 illustrates a plan view of a front side of an embodiment of a form of the present invention.

FIG. 2 illustrates a plan view of a front side of an embodiment of a form of the present invention having information printed thereupon.

FIG. 3 illustrates a flowchart of a method in an embodiment of the present invention

FIG. 4 illustrates a black box diagram of a system in an embodiment of the present invention.

### DETAILED DESCRIPTION OF THE PRESENTLY PREFERRED EMBODIMENTS

The present invention provides a form to accompany a document or document to be recorded and a method for using the same. The form may receive electronically-imaged data relevant to the recording of the document. The form may have a first layer having a plurality of detachable parts on which information may be imaged. The form may also have a second layer which may be attached to the first layer. The first layer may be removable from the second layer.

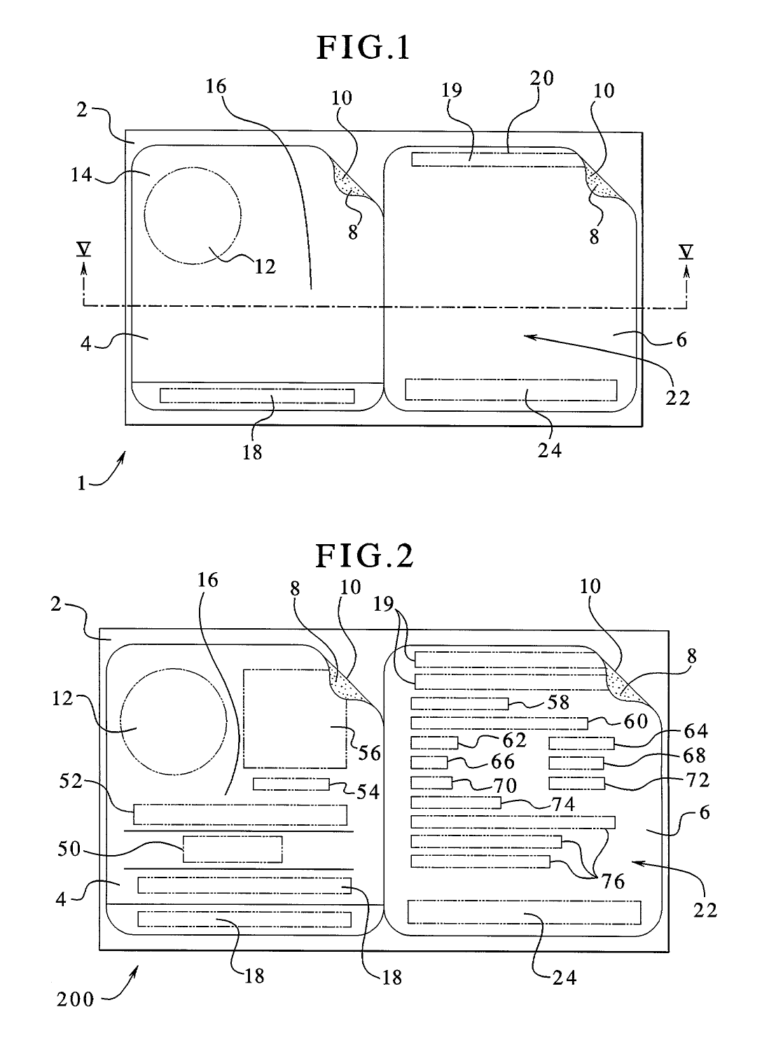

Referring now to the drawings wherein like numerals refer to like parts, FIG. 1 is a plan view of a form 1 and FIG. 5 is a cross-section taken along line V-V of FIG. 1. The form 1 may be constructed from archive-quality label stock and may have a backing layer 2 to which a first label 4 and a second label 6 may be attached. The first label 4 and the second label 6 may have an adhesive layer 8 on a bottom side 10 of the first label 4 and/or the second label 6. The adhesive layer 8 may be any adhesive known to those skilled in the art. The bottom side 10 may be pre-printed or capable of being printed upon. The first label 4 may be located adjacent to the second label 6. Alternatively, the first label 4 may be attached to the second label 6 by a perforation, score line, tear line, or other similar line of weakness or separation. Preferably, the backing layer 2 may be coated with a release layer 9, such as a silicone layer, for example, to facilitate removal of the first label 4 and/or the second layer 6 from the backing layer 2.

The first label 4 may have an insignia 12 located in a corner 14 of the first label 4. Preferably, the insignia 12 may be located in an upper corner of the first label 4. The insignia 12 may be, for example, an organizational logo, such as, for example, a government agency logo or the like. In addition, the first label 4 may have an area 16 in which information may be printed as illustrated in FIG. 2. Two identification sections 18 may also be provided in two different locations. The identification sections 18 may contain non-sequential numbers and/or letters that may be printed in a variety of sizes. Further, the ink used to print the information in FIG. 2 may be UV transparent security ink, security flourescent ink, black ink, colored ink, or the like. The non-sequential numbers and/or letters as well as the UV transparent security ink and/or security flourescent ink may be used as security measure to aid in the prevention of fraud.

The second label 6 may repeat the lettering and/or numbering which may be present in the identification sections 18 of the first label 4 in repeat identification sections 19. Preferably, the lettering and/or numbering is located in an upper section 20 of the second label 6 and the lettering and/or numbering is non-sequential to aid in the protection against fraud. The second label 6 may also have a second area 22 in which various data may be printed as illustrated in FIG. 2. In addition, the second label 6 may have a designation section 24 in which information may be printed to specify the function of the second label 6. The designation section 24 may display, for example, the caption “Receipt of Payment.”

The form 1 may accompany a document to be recorded, such as, for example, a document concerning the payment of a tax, a fee, or the like. FIG. 2 illustrates a form 200 which may have information printed on the first label 4 and the second label 6. The first label 4 may have a value printed in the area 50, such as, for example, the monetary amount paid to an organization. The name of an agency may be printed in an area 52. In addition, the date that the information is printed on the form 200 may be printed in an area 54. A section 56 may be provided for printing a mark, for example, specifying the sufficiency of the form 200 for recording a document.

The second label 6 may display the date at which time the information was printed in a section 58. The second label 6 may also display the agency name 60 and a caption 62, such as, for example, “Value”, indicating that a payment is being made. Further, the second label 6 may display the amount of the payment 64, a caption for any fees 66, or the like that may be added to the amount of the payment 64 and the actual amount of the fee 68. Still further, the second label 6 may provide a value and fees caption 70, such as, for example, “Total”, which may indicate the total of the value and/or fees paid by a user. The actual amount of the value and/or fees paid 72 may also be displayed.

The second label 6 may also have a descriptive section 74 which may display a caption such as, for example, “Description”. The descriptive section 74 may precede user information sections 76 which allow for user input information. For example, a user may electronically input information, such as, for example, a serial number, user name, type of document being recorded, insurance information, or the like to be printed on the second label 6.

Furthermore, the form 1 may be independent, or, the form 1 may be attached to a plurality of forms. Preferably, the form 1 and the plurality of forms are non-sequentially numbered. The non-sequential numbering may be used to help prevent fraud. Further, a watermark may be printed on the form 1 to help prevent fraud. The plurality of forms may be kept in a roll and inserted into, for example, a printer, or the like. The form 1 may also be inserted singly into a printer or the like.

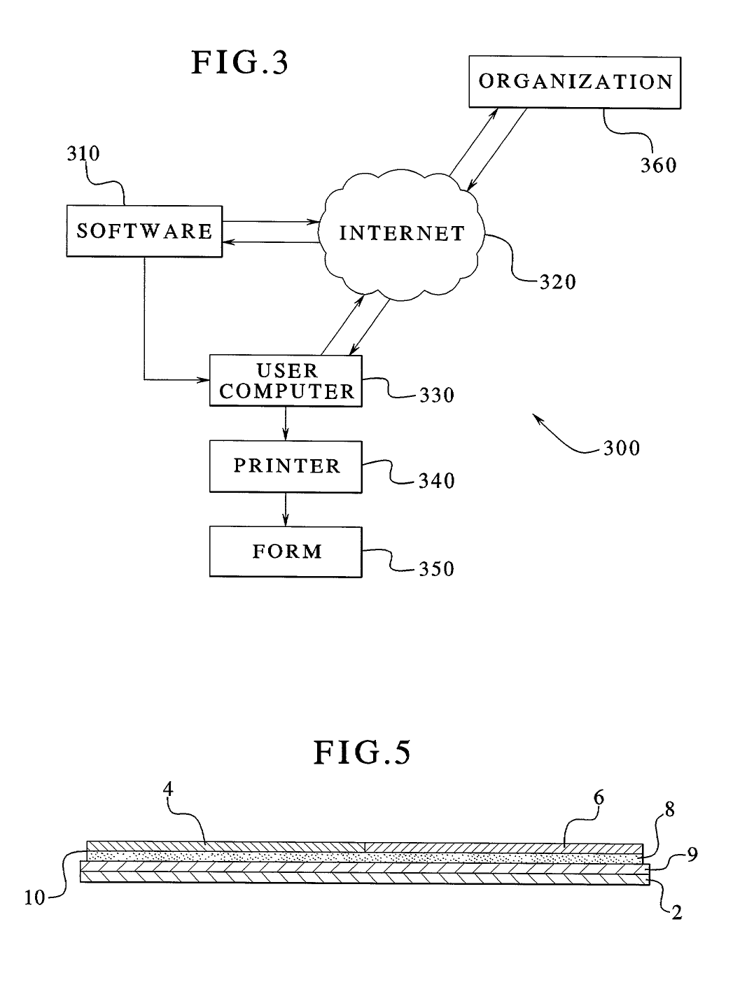

Referring now to FIG. 3, a black box diagram is illustrated showing an embodiment of a system 300 for printing and using a form associated with recorded documents for organizations. The system 300 has software 310 that may be accessed, for example, via the Internet, by purchase or other access of the software, or the like. A user computer 330 may access the software 310 via the Internet 320 and/or by purchase or other access of the software, or other like means. A printer 340 associated with the user computer 330 may print the necessary form 350. The forms may be in single sheets or may be part of a roll of forms wherein the forms and detachably connected. The organization 360 may communicate with the user computer 330 via the Internet 320 for billing and account information.

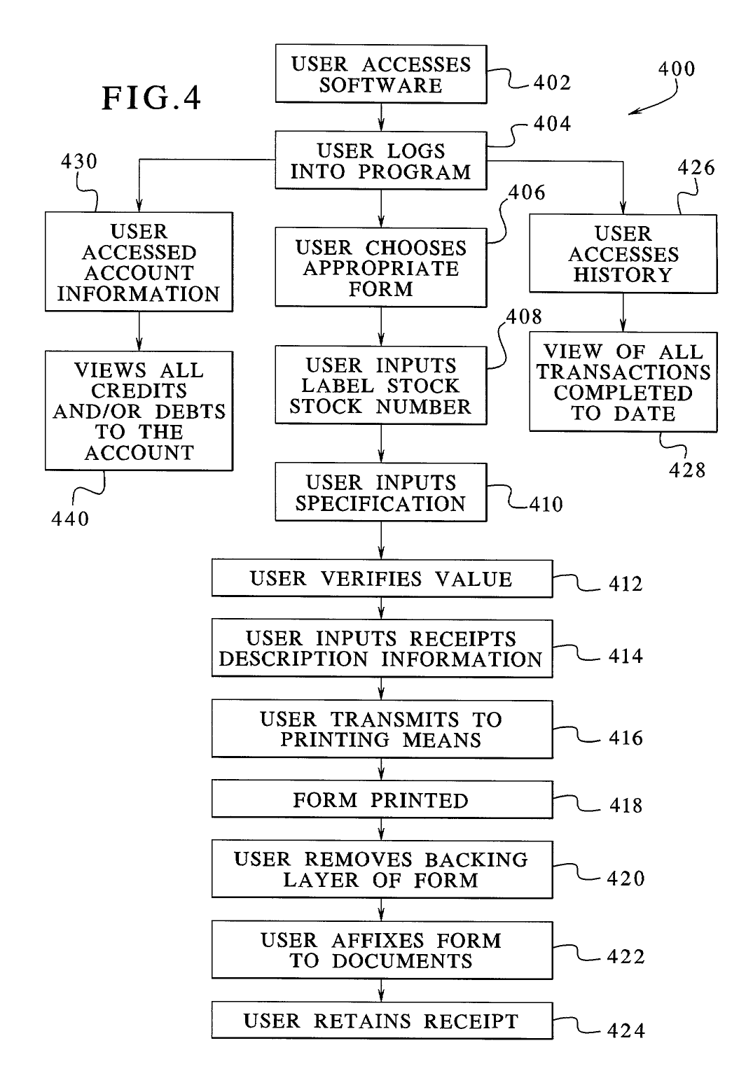

FIG. 4 illustrates a method 400 through which a user may use the form 1 in conjunction with a document to be recorded. The user may first access the software, via step 402, for printing onto the form 1 through the Internet or other global network system by use of a computer, for example, or the user may purchase the software and install the software onto a user computer, or the like. After the user has accessed the appropriate software, via step 402, the user may log into the program, via step 404. The user may then choose the appropriate form, via step 406. After choosing the appropriate form the user may input a label stock number, via step 408, and then input specifications, via step 410, to be printed on the label of the form, such as, for example, user information, the amount paid, the document type to be recorded, or the like.

Next, a user may verify values on the label, via step 412, and then input receipt description information, via step 414. The user may then transmit the information to a printing means, via step 416, such as, for example, a printer, and the information on the form 1 may be printed, via step 418. A user may then remove the backing, via step 420, from the first label 4 and/or second label 6 and affix the form 1 to the document to be recorded, via step 422. When the user presents the document for recording, the second label 6, which may not be affixed to the document, may be detached from the form and retained by the user as a receipt, via step 424.

The method illustrated in FIG. 4 also illustrates a method in which the user may access account information and a history of transactions the user has made in conjunction with a document to be recorded. After the user logs into the program, via step 404, the user may choose to access history, via step 426, choose an appropriate form, via step 406, or may choose to access account information, via step 430. After a user chooses to access history, via step 426, the user may view transactions completed to date that were transacted by the user, via step 428. After the user chooses to access account information, via step 430, the user may view all credits and/or debits to the account, via step 440.

A user of the software via the internet may have the history and account information automatically updated and may have an account set up with the organization for payment of the form records. However, a user that utilizes the software by purchasing a disc, or the like, and is not connected to a communicative source, such as, for example, the internet, may have to set up a separate billing system with the organization.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A form for recording of a document, the form comprising:
a first layer having a front side and a back side wherein the backside has an adhesive and further wherein the front side has a first label and a second label wherein the second label is a receipt;
a backing layer attached to the first layer by the adhesive wherein the first label and the second label on the front side receive electronically imaged information accessed over a global computer network wherein the electronically imaged information is necessary to effect the recording of the document.

2. The form of claim 1 further comprising:
a value printed on the first label and on the second label wherein the value represents a fee paid for the recording of the document.

3. The form of claim 1 further comprising:
a value caption on the second label indicative of payment.

4. The form of claim 1 further comprising:
a fee caption on the second label.

5. The form of claim 1 further comprising:
a mark on the first label wherein the mark is indicative of sufficiency of the form for recording the document.

6. The form of claim 1 further comprising:
a name printed on the first label and the second label wherein the name is indicative of an organization with which the document is recorded.

7. The form of claim 1 further comprising:
an insignia on the first label indicative of an organization with which the document is recorded.

8. The form of claim 1 further comprising:
identification information on the front side of the first label and the second label.

9. The form of claim 1 further comprising:
bar code information on the first label and on the second label.

10. The form of claim 1 further comprising:
security ink printed on the first label.

11. The form of claim 1 further comprising:
security ink printed on the second label.

12. The form of claim 1 further comprising:
a descriptive caption on the second label wherein a serial number is printed.

13. The form of claim 1 further comprising:
a descriptive caption on the second label wherein information is printed.

14. The form of claim 1 further comprising:
a date on the first label and the second label wherein the date is indicative of the date the form is prepared.

15. The form of claim 1 further comprising:
non-sequential numbering on the first label and the second label.

16. The form of claim 1 further comprising:
a custom stamp having encrypted symbols on the first label.

17. The form of claim 1 further comprising:
insurance information input by the user on the second label.

18. A system for recording of a document, the system comprising:
a form having a first layer and a backing layer wherein the backing layer is adhesively attached to the first layer and further wherein the first layer has a front side having a first label and a second label on the front side and further wherein the first label and the second label receive electronically imaged information;
a global computer network that transfers electronically imaged information to the form;
means for remotely accessing the global computer network; and
means for printing the information accessed over a global computer network onto the form.

19. The system of claim 18 further comprising:
a roll of forms wherein the forms are detachably connected.

20. A method for printing information relating to a recorded document, the method comprising the steps of:
providing a form having a first layer and a backing layer wherein the backing layer is adhesively attached to the first layer and further wherein the first layer has a first label and a second label and further wherein the second label is a receipt;
providing a global computer network to a user;
inputting information by the user to the global computer network;
printing information from the global computer network to the form;
removing the receipt from the form;
removing the backing layer from the first label; and
affixing the first label to the recorded document.

21. The method of claim 20 further comprising the step of:
printing a value on the first label and on the second label wherein the value represents a fee paid for the recorded document.

22. The method of claim 20 further comprising the step of:
printing a caption on the second label indicative of payment.

23. The method of claim 20 further comprising the step of:
printing a mark on the first label wherein the mark is indicative of sufficiency of the form for the recorded document.

24. The method of claim 20 further comprising the step of:
printing a name on the first label and on the second label wherein the name is indicative of an organization associated which the recorded document.

25. The method of claim 20 further comprising the step of:
printing an insignia on the first label indicative of an organization associated with the recorded document.

26. The method of claim 20 further comprising the step of:
printing information on the first label and the second label.

27. The method of claim 20 further comprising the step of:
using security ink on the first label and on the second label.

28. The method of claim 20 further comprising the step of:
printing a serial number on the second label.

29. The method of claim 20 further comprising the step of:
printing information associated with a type of recorded document on the second label.

30. The method of claim 20 further comprising the step of:
printing insurance information on the second label.

31. The method of claim 20 further comprising the step of:
printing a date on the first label and the second label wherein the date is indicative of the date the form is prepared.

32. The method of claim 20 further comprising the step of:
printing a security number on the first label and the second label.

33. The method of claim 20 further comprising the step of:
printing a stamp number on the first label and the second label.

34. The method of claim 20 further comprising the step of:
printing a custom stamp having encrypted symbols on the first label.

35. The method of claim 20 further comprising the step of:
printing insurance information input by the user on the second label.

36. The method of claim 20 further comprising the steps of:
providing a roll of forms wherein the forms are detachably connected; and
providing non-sequential numbering on the first label and on the second label.
